(19) United States
(12) Patent Application Publication
(10) Pub. No.: US 2026/0119969 A1
(43) Pub. Date: Apr. 30, 2026

(54) MACHINE LEARNING BASED PREDICTIVE INSIGHT SYSTEM AND METHOD

(71) Applicant: Profesy LLC, Palm Springs, FL (US)

(72) Inventor: Kevin Sloane, Palm City, FL (US)

(73) Assignee: Profesy LLC, Palm Springs, FL (US)

(21) Appl. No.: 18/927,189

(22) Filed: Oct. 25, 2024

(51) Int. Cl. G06N 20/00; G06T 19/00; G10L 25/63

(52) U.S. Cl. CPC G06N 20/00; G06T 19/006; G10L 25/63

(57) ABSTRACT

A predictive insight system is disclosed. The system may include a transceiver configured to receive user inputs from a user. The system may further include a memory configured to store a user profile and a trained machine module. The system may additionally include a processor configured to execute instructions stored in the trained machine module to determine a potential future event associated with the user based on the user inputs and the user profile. The processor may further determine a user emotional state, and an optimal output manner to output information associated with the potential future event to the user based on the user emotional state and the user profile. The processor may further output the information associated with the potential future event in the optimal output manner.

### TECHNICAL FIELD

The present disclosure relates to a machine learning based predictive insight system and method, and more particularly, to a predictive insight system and method that predicts a potential future life or career event associated with a user.

### BACKGROUND

Many users frequently try to enquire about major future events that may happen in their personal or professional lives. For example, a user may desire to know a probable age when the user may get married in the future, a possible time duration after which the user's business may become profitable, a possible time duration after which the user may get promoted or find a new job, information about potential life-threating medical condition that the user may encounter in the future, and/or the like.

Typically, to seek such information about major future events, the user reaches out to experts (e.g., psychics) who claim to predict user's future. Finding an appropriate and legitimate expert may be challenging, and many-a-times, a user may face inconvenience and disappointment after interacting with an expert who may not be skilled. Further, in many cases, the experts do not use scientific methods to predict a user's future.

Thus, a system is required that efficiently determines and provides information associated with the user's potential future events.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a plurality of example inputs and a plurality of example outputs associated with a predictive insight system in accordance with the present disclosure.

FIG. 3 depicts a snapshot of a user wearing an Augmented Reality (AR) display in accordance with the present disclosure.

FIG. 4 depicts a flow diagram of an example predictive insight method in accordance with the present disclosure.

### DETAILED DESCRIPTION

### Overview

The present disclosure describes a predictive insight system and method for predicting a potential future event for a user (e.g., a “first user”), and providing information associated with the potential future event to the user via a user device or an Augmented Reality (AR) headset. The future event may be associated with the user's personal life, user's professional life, user's health, and/or the like. The system may be configured to obtain user inputs (e.g., user queries as a verbal/audio message in natural language) and information associated with user profile, and may determine the potential future event for the user based on the user inputs and the user profile. In an exemplary aspect, the user profile may include information associated with user archetype, user preferences, user personal data, user health and lifestyle data, user dream data, user cultural and societal data, user career data, and/or the like.

The system may be an Artificial Intelligence/Machine Learning (AI/ML) based system that may store a trained machine module, which may be trained by using a training data including a correlation between a plurality of user profiles associated with a plurality of users (e.g., “second users”) and historical event patterns associated with the plurality of users. The system may execute instructions stored in the trained machine module to determine a potential future event for the user based on the user inputs provided by the user and the user profile.

In further aspects, the system may be configured to determine a user's emotional state when the user interacts with the system (e.g., when the user provides the user inputs to the system). In an exemplary aspect, the system may determine the user's emotional state based on language type or word choice used by the user while interacting with the system, usage frequency of one or more predefined terms or phrases used by the user, a voice tone, pace or rhythm of the user while interacting with the system, user's real-time biometric data, and/or the like.

Responsive to determining the user's emotional state, the system may determine an optimal manner in which to output information associated with the determined potential future event to the user. As an example, based on the user's emotional state, the system may determine an optimal message tone, choice of words, use of 3-dimensional holographic avatars, and/or the like, to optimally and efficiently relay/output the information associated with the determined potential future event to the user. Responsive to determining the optimal manner, the system may output the information in the determined optimal manner. In some aspects, the system may additionally generate a symbolic imagery (e.g., a tarot representation) associated with the determined potential future event, and may output the generated symbolic imagery simultaneously with (or independently of) the information associated with the determined potential future event.

In additional aspects, the system may be configured to determine a change in user's emotional state when the user interacts with the system. The system may generate customized messages/responses to user's queries and/or update the manner in which the messages are output to the user, based on the changes to the user's emotional state.

The present disclosure discloses a predictive insight system and method for predicting a potential future life event associated with a user. The system uses AI to predict the future life event, and relies on a huge amount of accurate historical data to make the predictions. The system outputs accurate predictions in a quick manner by analyzing historical data associated with thousands or millions of users. The system further automatically generates a symbolic imagery associated with the predictive future event, thereby enabling the user to easily comprehend the information associated with the predicted future event. The system may further enable the user to view the information associated with the predicted future event on an AR headset, thereby providing an immersive user experience.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

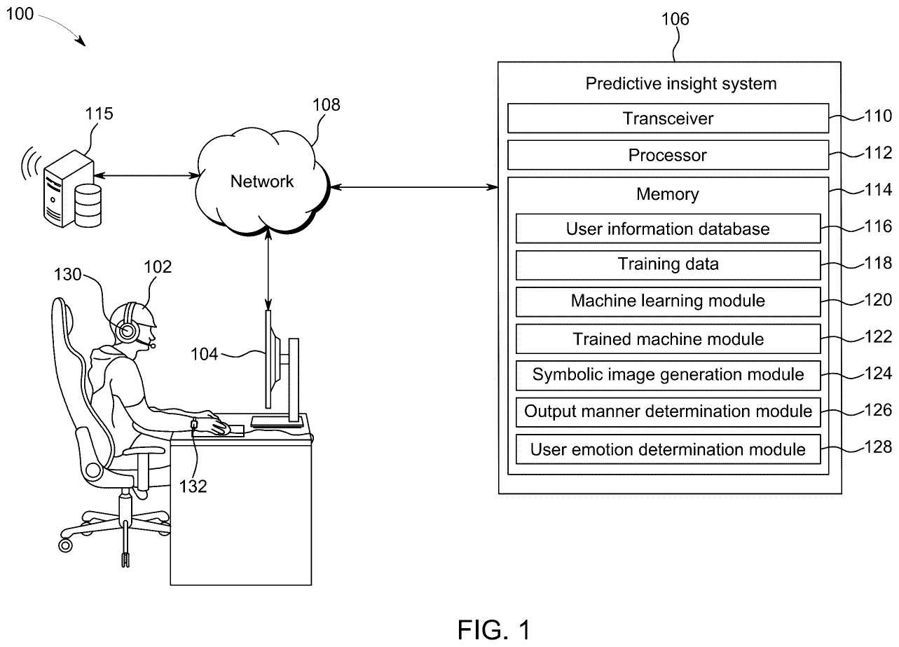

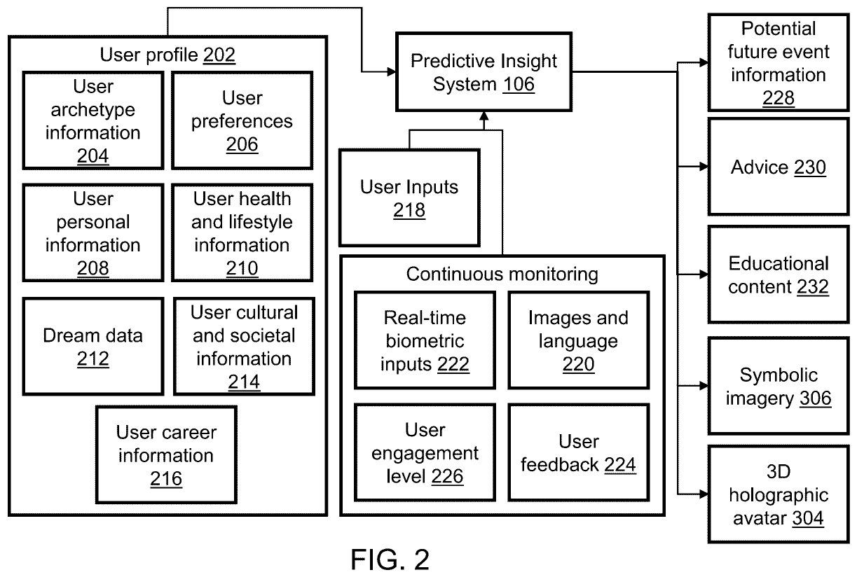

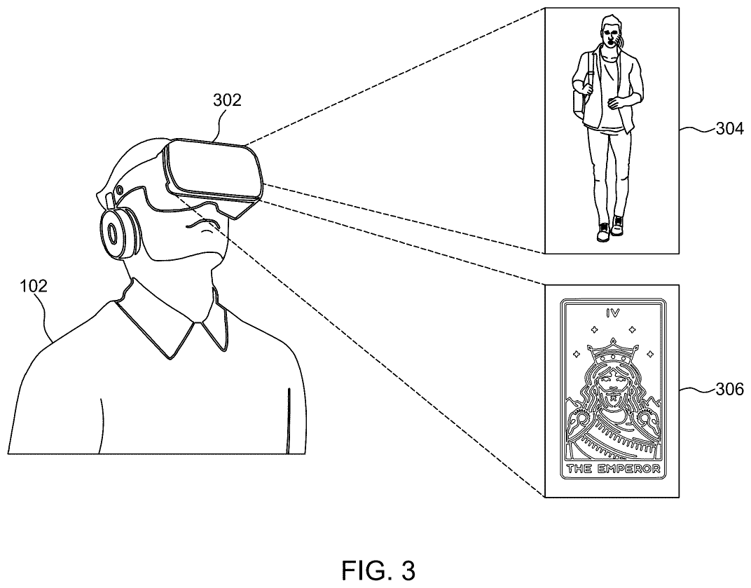

FIG. 1 depicts an example environment 100 in which techniques and structures for providing the systems and methods disclosed herein may be implemented. FIG. 1 will be described in conjunction with FIGS. 2 and 3.

The environment 100 may include a user 102 (e.g., a first user) who may be operating a user device 104. The user device 104 may be, for example, a computer, a laptop, a tablet, a mobile phone, or any other device with communication capabilities. The user device 104 may be communicatively coupled with a predictive insight system 106 (or system 106) via one or more networks 108 (or network 108).

The network 108 may be, for example, a communication infrastructure in which the connected devices discussed in various embodiments of this disclosure may communicate. The network 108 may be and/or include the Internet, a private network, public network or other configuration that operates using any one or more known communication protocols such as transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

In some aspects, the user 102 may be accessing the system 106 via a user interface (not shown) associated with the system 106 that may be rendered on the user device 104. For example, the user 102 may be accessing an application (or “app”) associated with the system 106 on the user device 106, to access the system 106. The system 106 may be hosted on a server or a distributed computing system, and may be implemented in hardware, software (e.g., firmware), or a combination thereof. In some aspects, the system 106 may be an Artificial Intelligence/Machine Learning (AI/ML) based system that may be configured to predict and output information associated with a potential or probabilistic future event associated with the user 102, based on a plurality of different types of inputs that the system 106 may obtain. The future event may be associated with a user's personal life, a user's professional life, a user's health, and/or the like. The inputs obtained by the system 106 are shown in FIG. 2, and described in detail later in the description below.

The system 106 may include a plurality of units including, but not limited to, a transceiver 110, a processor 112 and a memory 114, which may be communicatively coupled with each other. The transceiver 110 may be configured to receive/transmit information/data/signals from/to one or more internal system units or external devices via the network 108. For example, the transceiver 110 may be configured to receive user inputs from the user device 104, and transmit data/information to the user device 104 via the network 108. As another example, the transceiver 110 may be configured to receive data from one or more external servers 115 (or server 115) via the network 108.

The memory 114 may store programs in code and/or store data for performing various system operations in accordance with the present disclosure. Specifically, the processor 112 may be configured and/or programmed to execute computer-executable instructions stored in the memory 114 for performing various system functions in accordance with the disclosure. Consequently, the memory 114 may be used for storing code and/or data code and/or data for performing operations in accordance with the present disclosure.

In one or more aspects, the processor 112 may be in communication with one or more memory devices (e.g., the memory 114 and/or one or more external databases (not shown in FIG. 1)). The memory 114 can include any one or a combination of volatile memory elements (e.g., dynamic random-access memory (DRAM), synchronous dynamic random access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

The memory 114 may be one example of a non-transitory computer-readable medium and may be used to store programs in code and/or to store data for performing various operations in accordance with the present disclosure. The instructions in the memory 114 may include one or more separate programs, each of which can include an ordered listing of computer-executable instructions for implementing logical functions.

In some aspects, the memory 114 may include a plurality of modules and databases including, but not limited to, a user information database 116, training data 118, a machine learning module 120, a trained machine module 122, a symbolic image generation module 124, an output manner determination module 126, and a user emotion determination module 128. The machine learning module 120, the trained machine module 122, the symbolic image generation module 124, the output manner determination module 126 and the user emotion determination module 128, as described herein, may be stored in the form of computer-executable instructions, and the processor 112 may be configured and/or programmed to execute the stored computer-executable instructions for performing system functions in accordance with the present disclosure. The functions associated with the memory modules and the training data 118 may be understood in conjunction with the description provided below.

As described above, the system 106 may be an AI/ML based system that may be configured to predict and output information associated with a potential or probabilistic future event associated with the user 102. A person ordinarily skilled in the art may appreciate that machine learning is an application of Artificial Intelligence (AI) using which systems (e.g., the system 106) may have the ability to automatically learn and improve from experience without being explicitly programmed. Machine learning focuses on use of data and algorithms to imitate the way humans learn. In some aspects, the machine learning algorithms may be created to make classifications and/or predictions. Machine learning based systems may be used for a variety of applications including, but not limited to, speech recognition, email filtering, medical diagnosis, future prediction, and/or the like.

Machine learning may be of various types based on data or signals available to the learning system. For example, the machine learning approach may include supervised learning, unsupervised learning, semi-supervised learning, or reinforcement learning. The supervised learning is an approach that may be supervised by a human. In this approach, the machine learning algorithm may use labeled training data and defined variables. In the case of supervised learning, both the input and the output of the algorithm may be specified/defined, and the algorithms may be trained to classify data and/or predict outcomes accurately.

Broadly, the supervised learning may be of two types, “regression” and “classification”. In classification learning, the learning algorithm may help in dividing the dataset into classes based on different parameters. In this case, a computer program may be trained on the training dataset and based on the training, the computer program may categorize input data into different classes. Some known methods used in classification learning include Logistic Regression, K-Nearest Neighbors, Support Vector Machines (SVM), Kernel SVM, Naïve Bayes, Decision Tree Classification, and Random Forest Classification.

In regression learning, the learning algorithm may predict output value that may be of continuous nature or real value. Some known methods used in regression learning include Simple Linear Regression, Multiple Linear Regression, Polynomial Regression, Support Vector Regression, Decision Tree Regression, and Random Forest Regression.

The unsupervised learning is an approach that involves algorithms that may be trained on unlabeled data. An unsupervised learning algorithm may analyze the data by its own and find patterns in input data. Further, semi-supervised learning is a combination of supervised learning and unsupervised learning. A semi-supervised learning algorithm involves labeled training data; however, the semi-supervised learning algorithm may still find patterns in the input data. Reinforcement learning is a multi-step or dynamic process. This model is similar to supervised learning but may not be trained using sample data. This model may learn “as it goes” by using trial and error. A sequence of successful outcomes may be reinforced to develop the best recommendation or policy for a given problem in reinforcement learning.

In an exemplary aspect, the system 106 may use a supervised machine learning module (e.g., the machine learning module 120) for effectively predicting information associated with a potential or probabilistic future event associated with the user 102 (and a plurality of other users interacting with the system 106 via respective user devices). The machine learning module 120 may be trained by using the training data 118 (as labeled data) to generate the trained machine module 122 (e.g., distributed models). Specifically, the machine learning module 120 may generate the trained machine module 122 to effectively and accurately predict a potential future life or career event associated with the user 102.

The training data 118 may include correlations between a plurality of user profiles (e.g., “second user profiles”) and historical event patterns associated with a plurality of users (e.g., “second users”, whose count may be in thousands or millions). The system 106 may obtain the training data 118 from the server 115, and may be regularly updated, e.g., based on continuous interactions of a plurality of users with the system 106. As an example, the training data 118 may include correlations between users from different geographical areas, cultural and societal types, having different religious beliefs, different ages, different health conditions, users having different dietary habits, different exercise habits, and/or the like, with the details of major events that may have happened in their lives (e.g., marriage, birth of a child, career related activities, health/medical condition/disease onset, etc.). The training data 118 may also include information associated with user interactions and user inputs that these users (i.e., the second users) may have provided to the system 106 in the past. Examples of user inputs may include details of major life events that the users may themselves have shared with the system 106 during past user interactions.

The machine learning module 120 may train the trained machine module 122 by using the training data 118. In some aspects, the machine learning module 120 may keep on updating or “re-training” the trained machine module 122 based on regular user feedback and/or new training data that the system 106 may obtain from the server 115 and/or from multiple user interactions with the system 116.

In some aspects, the user information database 116 may be configured to store information (e.g., user profiles of the second users and/or the user 102) associated with a plurality of users (including the user 102). For example, the user information database 116 may store a user profile 202 (e.g., a first user profile 202) associated with the user 102. As shown in FIG. 2, in an exemplary aspect, the user profile 202 may include, but is not limited to, user archetype information 204 (e.g., a user personality type, behavior type, etc.), user preferences 206, user personal information 208, user health and lifestyle information 210, user dream data 212, user cultural and societal information 214, user career information 216, and/or the like. The system 106 may obtain the information described above associated with the user profile 202 directly from the user 102 via the user device 104, or from the server 115.

In some aspects, the user preferences 206 may include information associated with user's likes and dislikes associated with tone of communication, communication means (e.g., whether the user 102 likes textual messages, verbal messages, augmented reality (AR) based output, etc.) food, career types, travel, politics, and/or the like. In an exemplary aspect, the user preferences 206 may include any information that may assist the system 106 to understand user's likes or dislikes associated with a plurality of different topics/subjects.

The user personal information 208 may include information associated with user name, user gender, age, geographical place/location of birth, geographical place/location of upbringing, current geographical location, details of user's family members, details of major past/historical life events associated with personal life, and/or the like. The user health and lifestyle information 210 may include information associated with user's health (e.g., any existing medical condition or ailment), user's dietary habits (e.g., whether the user is vegetarian or eats meat, frequency of eating meat per week, etc.), user's regular exercise schedule, user's meditation schedule, user's vacation schedule, typical time duration the user spends in the office and with user's family and friends each day, and/or the like.

The user dream data 212 may include information/details associated with historical dreams that the user 102 may have had. Examples of such data include scary dreams, dreams with anxiety caused due to loss of job or family members/friends, happy or joyful dreams, etc. The user cultural and societal information 214 may include information associated with user's religious beliefs, views about politics, major topics affecting society/social living (e.g., views on LGBT community), and/or the like. The user career information 216 may include information associated with user's current job, past professional experience, current designation, future professional aspirations, and/or the like.

In operation, when the user 102 desires to know about user's potential future life events and/or obtain advice from the system 106, the user 102 may transmit, via the user device 104, user inputs 218 (or first user inputs) to the system 106. The transceiver 110 may be configured to receive the user inputs 218 from the user device 104 via the network 108, and transmit the user inputs 218 to the processor 112 and the memory 114 for storage purpose. In some aspects, the user inputs 218 may be a query or a response/sentence in natural language. For example, the user inputs 218 may include a query such as “When would I get married?”, “When would I get a new job?”, “Is there any major event waiting to happen in my life in the next 2 years that will affect my family and professional like?”, etc. In some aspects, the user inputs 218 may be in the form of a textual message that the user 102 may type on the user device 104, and transmit to the transceiver 110. In other and preferred aspects, the user inputs 218 may be in the form of a verbal or audio message that the user 102 may transmit to the system 106/transceiver 110 via a microphone 130 that the user 102 may be wearing (as shown in FIG. 1), a user device microphone (not shown), an AR headset device 302 that the user 102 may be wearing (as shown in FIG. 3), and/or the like. In this case, the transceiver 110 may receive the user inputs 218 in the form of verbal or audio message from the user 102 via one or more devices described above and the network 108.

Responsive to obtaining the user inputs 218 from the transceiver 110, the processor 112 may execute instructions stored in the trained machine module 122 to determine a potential future event associated with the user 102 based on the user inputs 218 and the user profile 202. In some aspects, the potential future event may be associated with user's health, career/professional life, and/or personal life. As an example, the processor 112 may determine an expected age of user marriage by determining users with similar profiles as the user 102 and the age when they got married (based on the trained machine module 122 that is trained using the training data 118, as described above). As another example, the processor 112 may determine that the user 102 may encounter a health scare (e.g., a heart attack or a stroke) in the next two years by determining users with similar profiles as the user 102 and their health history. For example, if the user 102 lives in the suburbs of a metropolitan area, and lives a stressful and sedentary lifestyle with no exercise schedule, the processor 112 may determine users with similar lifestyle data, and may determine that the user 102 may get a stroke or a heart attack within the next two years based on the health data (e.g., historical ailment records) associated with the determined users.

In addition to or responsive to determining the potential future event associated with the user 102, the processor 112 may execute instructions stored in the user emotion determination module 128 to determine user's emotional state (or sentimental state or frame of mind) when the user 102 interacts with the system 106 or provides the user inputs 218 to the system 106. In an exemplary aspect, the user's emotional state may be anxious, calm, agitated, stressed, happy, excited, uninterested, depressed, angry, etc.

In some aspects, the processor 112 may determine the user's emotional state by obtaining and/or monitoring user images and language 220 (e.g., language used in the user inputs 218). In a first exemplary aspect, the processor 112 may determine the user's emotional state by tracking user images that the processor 112 may obtain from a user device camera (not shown). In this case, the processor 112 may determine that the user 102 may be anxious or agitated when the user's eyes may be rolling or moving frequently when the user 102 provides the user inputs 218 to the system 106, or when the user 102 may be tilting or nodding user head frequently (e.g., more than a predefined threshold count of times in a minute), and/or the like. On the other hand, the processor 112 may determine that the user 102 may be calm when the user's eyes and/or gaze direction may be fixed at the user device 104 when the user 102 provides the user inputs 218 to the system 106. In this case, the memory 114 and/or the server 115 may pre-store a mapping between a plurality of images of different users (e.g., their facial expressions, eye movement patterns, etc.) and a plurality of user emotional states, and the processor 112/user emotion determination module 128 may correlate this mapping with the obtained images of the user 102 to determine the user's emotional state, as described above.

In a second exemplary aspect, the processor 112 may determine a language type and/or a word choice type associated with the user inputs 218 that the user 102 provides to the system 106, and then determine the user's emotional state based on the language type and/or the word choice type. For example, if the user 102 may be using rude language (which may not be common amongst the other users with similar user profiles as the user 102) or may be using slangs instead of regular standard natural language, the processor 112 may determine that the user 102 may be anxious. Further, if the user 102 may be using specific predefined terms or phrases (e.g., “I mean”, “like”, or offensive words towards a particular community/group of users) in the user inputs 218, the processor 112 may determine that the user 102 may be angry or agitated. In this case, the memory 114 and/or the server 115 may pre-store a mapping between a plurality of language type/word choice type and a plurality of user emotional states, and the processor 112/user emotion determination module 128 may correlate this mapping with the language type and/or the word choice type used by the user 102 in the user inputs 218 to determine the user's emotional state, as described above.

In a third exemplary aspect, the processor 112 may determine a usage frequency of one or more predefined words or phrases (e.g., the same phrases described above) in the user inputs 218, and may determine the user's emotional state based on the usage frequency. For example, if the user 102 may be using phrases like “I mean” or “like” too often (e.g., more than a predefined threshold count of times in a minute) in the user inputs 218, the processor 112 may determine that the user 102 may be nervous. In this case also, the memory 114 and/or the server 115 may pre-store a mapping between usage frequencies of one or more predefined words or phrases and a plurality of user emotional states, and the processor 112/user emotion determination module 128 may correlate this mapping with the determined usage frequency in the user inputs 218 to determine the user's emotional state, as described above.

In a fourth exemplary aspect, the processor 112 may determine a voice tone/pace associated with the user inputs 218, and may determine the user's emotional state based on the voice tone and/or pace. For example, if the user's voice tone may be loud and intimidating, the processor 112 may determine that the user 102 may be angry. On the other hand, if the user's voice tone/pace may be slow, the processor 112 may determine that the user 102 may be calm or nervous.

In a fifth exemplary aspects, the transceiver 110 may be configured to receive real-time biometric inputs 222 associated with the user 102 when the user 102 interacts with the system 106, and the processor 112 may determine the user's emotional state based on the real-time biometric inputs 222. Examples of the real-time biometric inputs 222 include, but are not limited to, a pulse rate, a heart rate, a blood pressure, and/or the like. As an example, the processor 112 may determine that the user 102 may be anxious or agitated when the user 102 may have an elevated pulse rate and/or heart rate (more than user's usual pulse rate and/or heart rate, as indicated in the user profile 202). In some aspects, the transceiver 110 may receive the real-time biometric inputs 222 from a wearable device 132 (via the network 108) that the user 102 may be wearing, as shown in FIG. 1. The wearable device 132 may be, for example, a smartwatch or any other similar wearable device configured to determine the user's biometric data. In this case also, the memory 114 and/or the server 115 may pre-store a mapping between a plurality of biometric data and a plurality of user emotional states, and the processor 112/user emotion determination module 128 may correlate this mapping with the real-time biometric inputs 222 to determine the user's emotional state, as described above.

Responsive to determining the user's emotional state by using one or more methods described above, the processor 112 may correlate the determined user's emotional state with the user profile 202. Specifically, the processor 112 may determine whether the determined user's emotional state is normal for the user 102 or a deviation from the user's normal behavior based on the information included in the user profile 202. In some aspects, responsive to determining that the determined user's emotional state is not normal for the user 102, the processor 112 may execute the instructions stored in the output manner determination module 126 to determine an optimal output manner to output the information associated with the determined potential future event to the user 102, based on the determined user emotional state and the user profile 202. In other aspects, irrespective of whether the determined user's emotional state is normal for the user 102 or not, the processor 112 may determine the optimal output manner to output the information associated with the determined potential future event to the user 102, based on the determined user emotional state and the user profile 202.

In some aspects, the optimal output manner may be associated with an audible message, which in turn may be associated with an optimal output message volume, an optimal output message choice of words, an optimal output message tone, use of 3-dimensional holographic avatar, and/or the like. As an example, if the user's emotional state indicates that the user 102 may be agitated or angry, the processor 112 may determine the optimal output manner such that the output message volume may be low and the output message tone may be calm. Further, the processor 112 may select the output message choice of words that may be easily understandable by the user 102 (e.g., based on dialect/words typically used by the people where the user 102 may have been born/brought-up). As another example, if the user 102 may be sad or may be missing user's deceased father or mother (as determined based on the user inputs 218 provided by the user 102 to the system 106), the processor 112 may generate a 3-dimensional holographic avatar 304 of the user's deceased father or mother (e.g., by using images of user's deceased father or mother stored in the user profile 202), and cause the generated 3-dimensional holographic avatar 304 to output/relay/speak a message (e.g., the information associated with the determined potential future event) to the user 102 to calm the user 102. The 3-dimensional holographic avatar 304 may be rendered on the AR headset device 302 (as shown in FIG. 3), or may be rendered on the user device 104. The example of the 3-dimensional holographic avatar 304 of the user's deceased father or mother should not be construed as limiting. The processor 112 may generate a 3-dimensional holographic avatar of any other user/person known to the user 102 to relay/output the information associated with the determined potential future event (e.g., to calm the user 102 or make the message output more impactful and relevant to the user 102).

Responsive to determining the optimal output manner, the processor 112 may output the information associated with the determined potential future event in the determined optimal output manner. In some aspects, the processor 112 may output the information associated with the determined potential future event in the determined optimal output manner on the AR headset device 302, if the user 102 may be wearing the AR headset device 302. In this case, the AR headset device 302 may be communicatively coupled with the system 106 via the network 108, and the processor 112 may transmit the information associated with the determined potential future event and the details associated with the determined optimal output manner to the AR headset device 302 via the transceiver 110, so that the AR headset device 302 may efficiently display/render the information associated with the determined potential future event. In other aspects, the processor 112 may output the information associated with the determined potential future event in the determined optimal output manner on the user device 104 (e.g., if the user 102 may not be wearing the AR headset device 302).

The information associated with the determined potential future event may be output as an audible message as described above. In alternative or additional aspects, the information associated with the determined potential future event may also be output as a textual message (e.g., via a chatbox). In additional aspects, the information associated with the determined potential future event may also be output as a symbolic image 306 (which may be, e.g., a tarot representation or a tarot card, as shown in FIG. 3). In this case, the processor 112 may execute the instructions stored in the symbolic image generation module 124 to first generate the symbolic image 306 associated with the determined potential future event. In some aspects, the processor 112 may generate the symbolic image 306 by using a database of a plurality of symbolic images that may be stored in the memory 114 or the server 115. The memory 114 and/or the server 115 may also store a mapping of a plurality of potential future events with the plurality of symbolic images, and the processor 112 may generate the symbolic image 306 for the user 102 by correlating the determined potential future event with this mapping that the processor 112 may fetch from the memory 114 and/or the server 115. In other aspects, the processor 112 may use artificial intelligence and the mapping described above to create/generate a customized symbolic image 306 (that may not be included in the plurality of symbolic images stored in the memory 114 and/or the server 115) for the user 102 based on the determined potential future event.

Responsive to generating the symbolic image 306 as described above, the processor 112 may output the symbolic image 306 simultaneously with the information associated with the determined potential future event on the AR headset 302 and/or the user device 104.

The processor 112 may be further configured to continuously monitor user interaction with the system 106, and provide customized messages in a customized manner to the user 102 via the user device 104 and/or the AR headset 302 based on the continuous monitoring. For example, the processor 112 may determine a change in the user's emotional state responsive to outputting the information associated with the potential future event as described above. In some aspects, the processor 112 may determine the change in the user's emotional state by tracking the changes to the real-time biometric inputs 222, or by tracking user feedback 224 (e.g., by tracking user's hand, face or eye gesture, user's explicit feedback that the user 102 types on the user device 104, and/or the like), or by tracking user's engagement level 226 in the user interaction with the system 106. As an example, if the user 102 may be providing short, one-word responses to the system 106, the processor 112 may determine that the user's emotional state may have changed to disengaged or uninterested.

Responsive to determining the change in the user's emotional state, the processor 112 may determine an optimal customized response and an updated optimal output manner based on the change in the user's emotional state, and output the optimal customized response in the updated optimal output manner. For example, if the user 102 may have become sad (from an earlier emotional state of “excited”) after hearing/viewing the information associated with the potential future event, the processor 112 may output a customized soothing or reassuring message to the user 102 in a calm and slow tone, to move the user 102 away from the sad emotional state.

A person ordinarily skilled in the art may appreciate from the description above that the system 106 may be configured to output a plurality of outputs for the user 102, e.g., potential future event information 228 (or the information associated with the determined potential future event), the symbolic imagery 306, and the 3-dimensional holographic avatar 304 based on the plurality of inputs received by the system 106, as shown in FIG. 2. In additional aspects, the system 106 may be configured to output advice 230 and/or educational content 232 based on the plurality of inputs received by the system 106. For example, if the system 106/processor 112 determines that the user 102 may be sad, the processor 112 may output the advice 230 to the user 102 indicating that the user 102 may try one or more meditation courses to reduce the user's sadness. The processor 112 may also recommend the educational content 232 including self-help books, or courses to propel career trajectory, improve people management skills, and/or the like, based on specific user inputs 218 provided by the user 102 to the system 106.

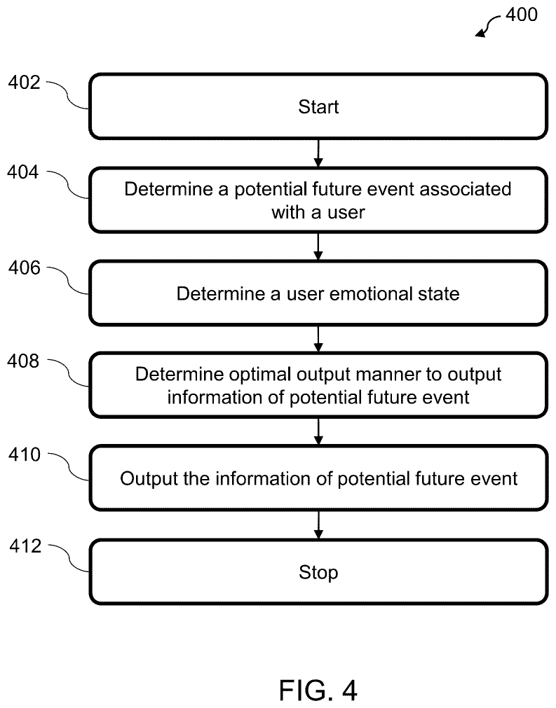

FIG. 4 depicts a flow diagram of an example predictive insight method 400 in accordance with the present disclosure. FIG. 4 may be described with continued reference to prior figures, including FIGS. 1-3. The following process is exemplary and not confined to the steps described hereafter. Moreover, alternative embodiments may include more or less steps than are shown or described herein and may include these steps in a different order than the order described in the following example embodiments.

Referring to FIG. 4, at step 402, the method 400 may commence. At step 404, the method 400 may include determining, by the processor 112, the potential future event associated with the user 102 based on the user profile 202 and the user inputs 218 by executing the instructions stored in the trained machine module 122. At step 406, the method 400 may include determining, by the processor 112, the user's emotional state, as described above in conjunction with FIG. 1.

At step 408, the method 400 may include determining, by the processor 112, the optimal output manner to output the information associated with the determined potential future event to the user 102, based on the user's emotional state and the user profile 202. At step 410, the method 400 may include outputting, by the processor 112, the information associated with the potential future event in the optimal output manner.

At step 412, the method 400 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A predictive insight system comprising:
a transceiver configured to receive first user inputs from a first user;
a memory configured to:
store a first user profile, wherein the first user profile comprises first user cultural and societal information; and
store a training data and a trained machine module, wherein:
the trained machine module is trained using the training data, and
the training data comprises a correlation between a plurality of second user profiles and historical event patterns associated with a plurality of second users; and
a processor communicatively coupled with the transceiver and memory, wherein the processor is configured to:
execute instructions stored in the trained machine module to determine a potential future event associated with the first user based on the first user inputs and the first user profile;
determine a first user emotional state;
determine an optimal output manner to output information associated with the potential future event to the first user, based on the first user emotional state and the first user profile; and
output the information associated with the potential future event in the optimal output manner.

2. The predictive insight system of claim 1, wherein the first user inputs comprise a first user query or a first user response in natural language.

3. The predictive insight system of claim 2, wherein the transceiver receives the first user inputs in a form of a verbal message from the first user.

4. The predictive insight system of claim 1, wherein the first user profile further comprises a first user place of birth.

5. The predictive insight system of claim 1, wherein the first user profile further comprises first user preferences.

6. The predictive insight system of claim 1, wherein the first user cultural and societal information comprises a first user religious belief.

7. The predictive insight system of claim 1, wherein the first user profile further comprises one or more of information associated with a first user career, information associated with a first user family, and first user health information.

8. The predictive insight system of claim 1, wherein the first user profile further comprises information associated with first user dream data.

9. The predictive insight system of claim 1, wherein the potential future event is associated with a first user health, a first user career, or a first user personal life.

10. The predictive insight system of claim 1, wherein the processor is further configured to:
determine a language type and a word choice type associated with the first user inputs; and
determine the first user emotional state based on the language type and the word choice type.

11. The predictive insight system of claim 1, wherein the processor is further configured to:
determine a usage frequency of one or more predefined words or phrases in the first user inputs; and
determine the first user emotional state based on the usage frequency.

12. The predictive insight system of claim 1, wherein the processor is further configured to:
determine a voice tone associated with the first user inputs; and
determine the first user emotional state based on the voice tone.

13. The predictive insight system of claim 1, wherein the transceiver is further configured to receive real-time biometric inputs associated with the first user, and wherein the processor is further configured to determine the first user emotional state based on the real-time biometric inputs.

14. The predictive insight system of claim 13, wherein the transceiver receives the real-time biometric inputs from a wearable device worn by the first user.

15. The predictive insight system of claim 1, wherein the optimal output manner is associated with an output message volume, an output message choice of words, an output message tone, and use of a 3-dimensional holographic avatar.

16. The predictive insight system of claim 1, wherein the processor is further configured to:
generate a symbolic image associated with the potential future event, wherein the symbolic image is a tarot representation; and
output the symbolic image simultaneously with the information associated with the potential future event.

17. The predictive insight system of claim 1, wherein the processor outputs the information associated with the potential future event on an Augmented-Reality (AR) display.

18. The predictive insight system of claim 1, wherein the processor is further configured to:
determine a change in the first user emotional state responsive to outputting the information associated with the potential future event;
determine an optimal customized response and an updated optimal output manner based on the change in the first user emotional state; and
output the optimal customized response in the updated optimal output manner.

19. A predictive insight method comprising:
executing, by a processor, instructions stored in a trained machine module to determine a potential future event associated with a first user based on first user inputs and a first user profile, wherein:
the first user profile comprises first user cultural and societal information,
the trained machine module is trained using a training data, and
the training data comprises a correlation between a plurality of second user profiles and historical event patterns associated with a plurality of second users;
determining, by the processor, a first user emotional state;
determining, by the processor, an optimal output manner to output information associated with the potential future event to the first user, based on the first user emotional state and the first user profile; and
outputting, by the processor, the information associated with the potential future event in the optimal output manner.

20. A non-transitory computer-readable storage medium in a distributed computing system, the non-transitory computer-readable storage medium having instructions stored thereupon which, when executed by a processor, cause the processor to:
execute instructions stored in a trained machine module to determine a potential future event associated with a first user based on first user inputs and a first user profile, wherein:
the first user profile comprises first user cultural and societal information,
the trained machine module is trained using a training data, and
the training data comprises a correlation between a plurality of second user profiles and historical event patterns associated with a plurality of second users;
determine a first user emotional state;
determine an optimal output manner to output information associated with the potential future event to the first user, based on the first user emotional state and the first user profile; and
output the information associated with the potential future event in the optimal output manner.
